(19) United States
(12) Patent Application Publication
(10) Pub. No.: US 2014/0162247 A1
(43) Pub. Date: Jun. 12, 2014

(54) MOLECULAR TRANSISTOR

(71) Applicants: Stuart Lindsay, Phoenix, AZ (US); Pei Pang, Tempe, AZ (US); Jin He, Mesa, AZ (US)

(72) Inventors: Stuart Lindsay, Phoenix, AZ (US); Pei Pang, Tempe, AZ (US); Jin He, Mesa, AZ (US)

(21) Appl. No.: 14/003,851

(22) PCT Filed: Mar. 9, 2012
(86) PCT No.: PCT/US12/28549

§ 371 Date: Feb. 18, 2014

Related U.S. Application Data
(60) Provisional application No. 61/450,785, filed on Mar. 9, 2011.

(51) Int. Cl. G01N 27/414

(52) U.S. Cl. CPC G01N 27/4146
USPC 435/6.1; 257/9; 204/451

(57) ABSTRACT

Fluidic nanotube devices and methods for their use are provided wherein the flow of charged molecules through a channel is controlled by the voltage potential of a gate electrode. In at least some embodiments, a molecular transistor is provided that includes a channel having a diameter such that only one target molecule at a time may traverse the channel. The channel may be a carbon nanotube that is electrically isolated from, and in communication with, a gate electrode. Methods are provided for controlling the flow of an individual molecule through the channel and for detecting a single chemical reaction.

### CROSS REFERENCE TO RELATED APPLICATION

This claims the benefit of U.S. Provisional Patent Application No. 61/450,785, filed Mar. 9, 2011, which is hereby incorporated by reference herein in its entirety.

### STATEMENT REGARDING FEDERALLY SPONSORED RESEARCH OR DEVELOPMENT

This work was supported by grant/contract number 1RC2HG005625-01, awarded by the National Institutes of Health. The U.S. government has certain rights in the invention.

### TECHNICAL FIELD

The disclosed subject matter relates generally to fluidic devices, and more particularly to fluidic nanotubes and devices made therefrom. The disclosed subject matter also relates to methods for controlling the flow of individual molecules and to methods for detecting a single chemical reaction.

### BACKGROUND

Many efforts to control the speed with which molecules pass through a small orifice have been reported, mainly in connection with new approaches to DNA sequencing, though without much success so far. (Branton, D. et al., Nanopore Sequencing, Nature Biotechnology 2008; 26:1146-1153.)

A multielectrode device operating at high voltage has been proposed for trapping and manipulating DNA (see “IBM Research Aims to Build Nanoscale DNA Sequencer to Help Drive Down Cost of Personalized Genetic Analysis,” Oct. 6, 2009, at http://www-03.ibm.com/press/us/en/pressrelease/28558.wss), and is described in U.S. Patent Application Publication No. 2008/0187915. A representative cross section of that device is shown in FIG. 1A. The fabrication of such a device is complex, requiring multistep processes with nanometer scale critical dimensions. Furthermore, control of the flow rate of single molecules through such a device has not yet been demonstrated. A further disadvantage of the device of FIG. 1A is that the electrodes of the disclosed device are in electrical contact with the electrolyte within the channel through which molecules are meant to pass. This can result in unwanted electrochemical currents in the device, and also can fix the potential of the electrode surface. That is to say, by connecting the surface electrically to an external circuit, its potential cannot readily be changed by the entry of a single molecule into the channel. Since this appears to be a requirement for the transit of certain molecules, this greatly restricts the uses of such devices.

A much simpler approach has been implemented by E. B. Kalman et al. (“Control of ionic transport through gated single conical nanopores,” Anal. Bioanal. Chem. 2009; 394:413-419), and is illustrated in FIG. 1B. This device has a metal gate isolated from direct contact with the electrolyte in the conical nanopore by a thin layer of oxide, and it has been shown to be capable of controlling the flow of ion current through the nanopore by means of a potential applied to the gate. However, control of the speed of flow of molecules in the channel has not been demonstrated.

U.S. Pat. No. 7,355,216 describes a device for gating ion flow through a non-carbon nanotube, shown in FIG. 1C. Ion current is driven through the tube by the application of a bias 144 between source and drain electrodes in ionic fluid reservoirs 140 and 142, respectively. A gate electrode 146 is connected directly to the tube. This arrangement, however, does not allow the potential of the tube to change when large charged molecules like DNA or DNA nucleotides enter the tube. To control the flow of such molecules through the tube, it is essential that the potential of the tube be able to change when such molecules enter the tube. Control of molecular flow was not demonstrated for the device described in U.S. Pat. No. 7,355,216.

The present applicants have demonstrated that DNA molecules will flow through a single-walled carbon nanotube connecting two fluid reservoirs when an ionic current is driven through the carbon nanotube by means of electrodes in contact with the reservoirs on each side of a barrier spanned by the carbon nanotube. This work is described by Liu et al. (Liu, H., J. He, J. Tang, H. Liu, P. Pang, D. Cao, P. S. Krstic, S. Joseph, S. Lindsay, and C. Nuckolls; “Translocation of single-stranded DNA through single-walled carbon nanotubes,” Science 2010; 327:64-67), which is hereby incorporated by reference herein in its entirety. Unlike the device described herein, however, the device of Liu et al. does not enable control of both the flow of ionic current through the tube and the flow of any charged molecules dissolved in the electrolyte.

A need exists for a microfluidic device that precisely controls the flow of individual molecules through a channel under direct electronic control.

### SUMMARY

Accordingly, a “molecular transistor” is provided that precisely controls the flow of individual molecules through a channel under direct electronic control. The molecular transistor has a gate electrode that is chemically and electrically isolated from the channel through which the flow of molecules occurs and, in at least some embodiments, the molecular transistor is easily manufactured.

In at least some embodiments, the molecular transistor is a device that has a channel, wherein the channel (1) has a diameter such that only one target molecule at a time may traverse the channel; (2) is electrically isolated by means of a layer of dielectric material; and (3) is in communication with a gate electrode. The channel diameter may be between about 0.1 and about 100 nm. The channel may include a carbon nanotube or any other isolated, but electrically conducting cylinder of internal dimensions comparable to those of the molecules whose flow is to be controlled. Such devices may be formed from any metal that can be formed by chemical vapor deposition including molybdenum, tantalum, nickel titanium, and tungsten. The layer of dielectric material maybe between about 1 and about 50 nm thick. The dielectric material may be selected from the group consisting of an oxide of silicon, a metal oxide (including, but not limited to, aluminum oxide, hafnium dioxide, zirconium dioxide, or any compound formed by a metal and oxygen in which the oxygen has an oxidation number of −2), silicon nitride, and polymethyl-methacrylate.

In at least some embodiments, a method is provided for controlling the flow of one or more individual molecules through a channel. The method may include providing a device that has a channel, wherein the channel has proximal and distal ends, and a diameter such that only one target molecule at a time may traverse the channel. The channel is electrically isolated by a layer of dielectric material and is in communication with a gate electrode, wherein the gate electrode has a voltage potential (Vg) and a gate current (Ig). The method may also include providing the molecule to the proximal end of the channel; detecting the gate current of the gate electrode; and controlling the voltage potential of the gate electrode, thereby controlling the flow of the molecule. The method may further include detecting a current spike in the gate current (Ig) and/or the channel ionic current (Ii), thereby detecting translocation of a molecule through the channel.

In at least some embodiments, a method is provided for detecting a single chemical reaction. The method may include providing a device that has a channel, wherein the channel includes a carbon nanotube having proximal and distal ends and a catalytic molecule tethered to the distal end. The carbon nanotube further has a diameter such that only one target molecule at a time may traverse the channel. The channel is electrically isolated by a layer of dielectric material, and is in communication with a gate electrode, wherein the gate electrode has a voltage potential (Vg) and a gate current (Ig). The method may also include providing a molecule to the proximal end of the channel; optionally controlling the voltage potential of the gate electrode; and detecting the gate current of the gate electrode, thereby detecting the single chemical reaction.

### BRIEF DESCRIPTION OF THE DRAWINGS

FIGS. 1A-1C show known microfluidic devices. In particular, FIG. 1A shows a known DNA transistor (see FIG. 1 of U.S. Patent App. Pub. No. 2008/0187915). FIG. 1B shows a known conical gated nanopore (see FIGS. 1A and 1B of Kalman et al). And FIG. 1C shows a known nanofluidic transistor (see FIG. 27 of U.S. Pat. No. 7,355,216).

FIGS. 2A-2D show a molecular transistor in accordance with at least some embodiments. In particular, FIG. 2A shows a cross section of the molecular transistor device along the axis of the carbon nanotube. FIG. 2B shows a cross section perpendicular to the carbon nanotube axis through the gate area, showing the fabrication of the gate structure. FIG. 2C shows a scanning electron microscope image of a carbon nanotube on a substrate, which shows index markers used for subsequent stages of lithography. And FIG. 2D shows an optical micrograph of an assembled device.

FIG. 3 shows gating of ion current through the molecular transistor, represented as a three dimensional “heat map” showing measured ion current through the transistor as a function of bias applied between the reservoirs, Vionic, and the gate bias, Vg, in accordance with at least some embodiments.

FIG. 4 shows change in ion current vs. time as a charged molecule, deoxyguanosinemono-phosphate, is added to the negatively biased reservoir in accordance with at least some embodiments. The spikes in current indicate single molecule translocations.

FIGS. 5A-D show molecular transistor action in accordance with at least some embodiments. In particular, FIG. 5A shows that a negative gate bias does not affect the flow. FIG. 5B shows that the flow is reduced at positive gate bias. FIG. 5C shows the flow turning off completely. Note that the operation of the device is completely reversible. And FIG. 5D shows the gate current over the time interval where molecular flow is turned off, showing how ionic current spikes are mirrored by spikes in the gate current.

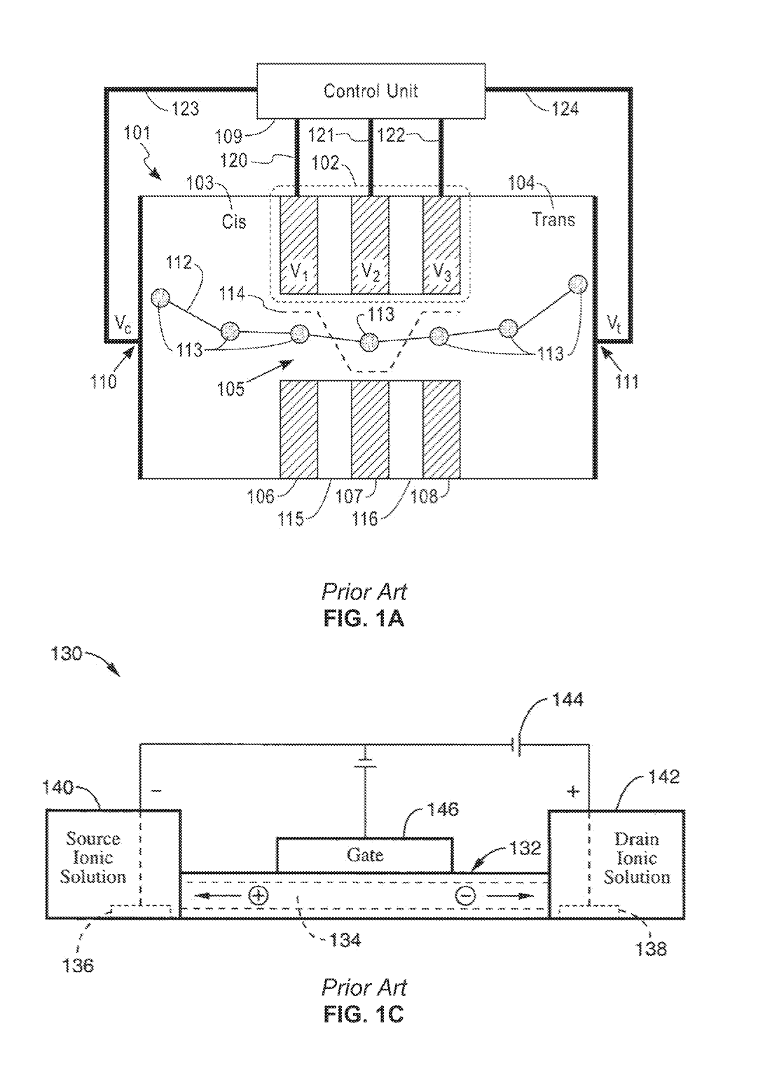

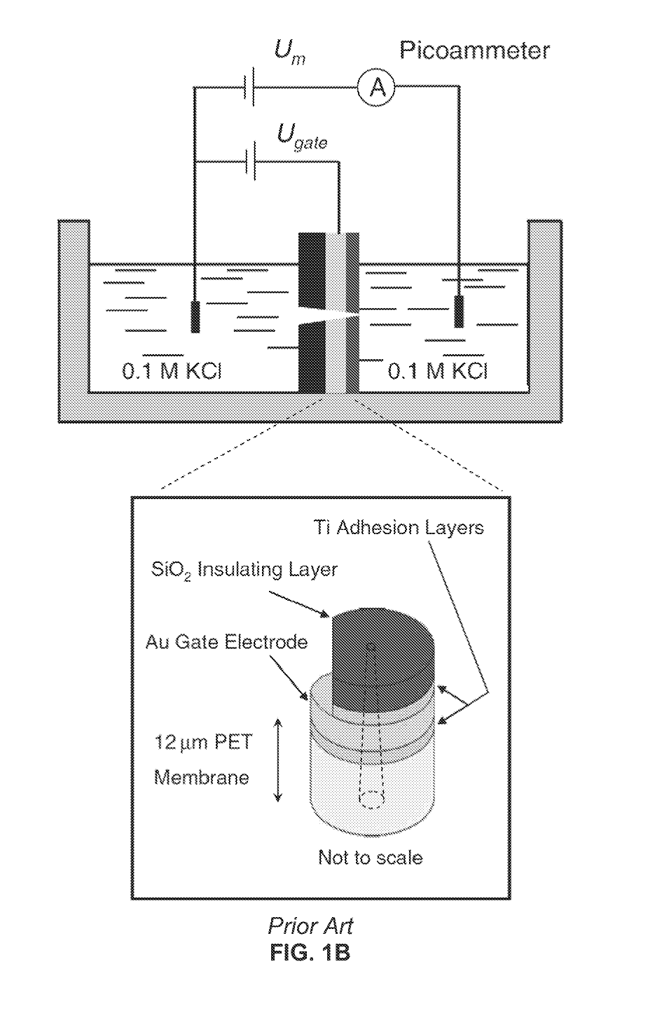

### DETAILED DESCRIPTION

It should be understood that the disclosure is not limited to the particular embodiments described below, because variations of the particular embodiments maybe made that still fall within the scope of the appended claims. It should also be understood that the terminology used herein is for the purpose of describing particular embodiments, and is not intended to be limiting. Instead, the scope of the disclosure should be established by the appended claims.

Other than in the operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth herein are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure herein are approximations, the numerical values set forth in the specific examples are reported as precisely as possible. Any numerical values, however, inherently contain certain errors necessarily resulting from the standard deviation found in their respective testing measurements.

It should also be understood that any numerical range recited herein is intended to include all sub-ranges subsumed therein. For example, a range of 1 nm to 10 nm is intended to include all sub-ranges between and including the recited minimum value of 1 and the recited maximum value of 10, that is, having a minimum value equal to or greater than 1 and a maximum value equal to or less than 10.

As used herein, the singular forms “a,” “an,” and “the” include plural reference unless the context clearly dictates otherwise. Unless defined otherwise, all technical and scientific terms used herein have the same meaning as commonly understood by one of ordinary skill in the art to which this disclosure belongs.

Simulations of ion current flow through a carbon nanotube show that it is dominated by an electroosmostic flow of water that drags anions and cations with it. A net current flows because the entry of anions or cations into the tube is selective, depending upon factors such as surface charges at the entrance to the carbon nanotube. Accordingly, the number of cations in the tube may not equal the number of anions, giving rise to a net charge inside the tube and, accordingly, a net current flow through the tube. This mechanism is described by Liu et al.

In at least some embodiments, the charge carried by the carbon nanotube can be controlled by an electrically-isolated gate electrode placed in close proximity to the carbon nanotube, but insulated from it by a dielectric layer. This arrangement allows the potential of the carbon nanotube to vary, or “float,” yet remain under control of the gate electrode as well, which enables control of both the flow of ionic current through the tube, and the flow of any charged molecules dissolved in the electrolyte. Unlike known devices, the electrodes of the molecular transistor are not in electrical contact with the electrolyte within the channel through which molecules are meant to pass. As demonstrated below, the molecular transistor in accordance with at least some embodiments enables detection of single-molecule translocation events as well as control of the speed of flow of molecules in the channel.

The ability to manipulate the speed with which molecules pass a barrier has many applications besides UNA sequencing. Examples include, but are not limited to:
(1) Massively parallel devices for synthesizing new reagents, utilizing arrays of millions of electronically controlled reactors into which “molecular transistors” inject reagents under computer control;
(2) Sensors, in which selected molecules are slowed so that they accumulate at the entrance to a “molecular transistor,” to be controllably released at enormously enhanced concentrations for detection, ail under electronic control;
(3) Computers, in which electronic calculations are interfaced to chemical reactions. For example, releasing controlled amounts of DNA molecules into a reactor in a precisely timed sequence may enable a new type of computer based on hybridization of DNA molecules of complementary sequence; and

(4) Sensors for chemical reactions involving single molecules. For example, one approach to DNA sequencing relies on detection of charge transferred during the addition of nucleotides (see, e.g., Pourmand, N., M. Karhanek, H. H. J. Persson, C. D., Webb, T. H. Lee, A. Zahradrukova, and R. W. Davis, “Direct electrical detection of DNA synthesis,” Proc. Natl. Acad. Sci. (USA) 2006; 103:6466-6470, incorporated by reference herein in its entirety).

The device in accordance with some embodiments may be applied to measuring such reactions at the single molecule level.

The work of Liu et al. pointed out that translocation of DNA molecules through electrically-isolated single-walled carbon nanotubes was signaled by giant charge pulses, each containing about 107 units of electronic charge. Since this is more charge, by many orders of magnitude, than can be packed into the space available in the carbon nanotube channel, it was hypothesized that translocation of the channel by a charged molecule was accompanied by a large change in polarization of the channel. Accordingly, the charge on the channel must change by a large amount when a charged molecule translocates. The carbon nanotube acts as a “charge amplifier.” Therefore, the potential of the carbon nanotube may change during translocation. Thus, by a reciprocal action, control of the potential of the carbon nanotube may enable control of the rate of translocation of the tube by charged molecules. That action is demonstrated and confirmed in accordance with at least some embodiments.

The use of a physically small, isolated channel is another important aspect in accordance with at least some embodiments. In the device of Kalman et al., electrolyte throughout the channel region can respond to changes in gate potential. In the molecular transistor of at least some embodiments, however, the potential of the entire carbon nanotube channel can be controlled by the gate electrode and even a single molecule inside the carbon nanotube can block the flow of small ions around it. If the potential of the carbon nanotube is not allowed to float, or if it cannot float, then no molecules can translocate through the nanotube unless its inner diameter is relatively large.

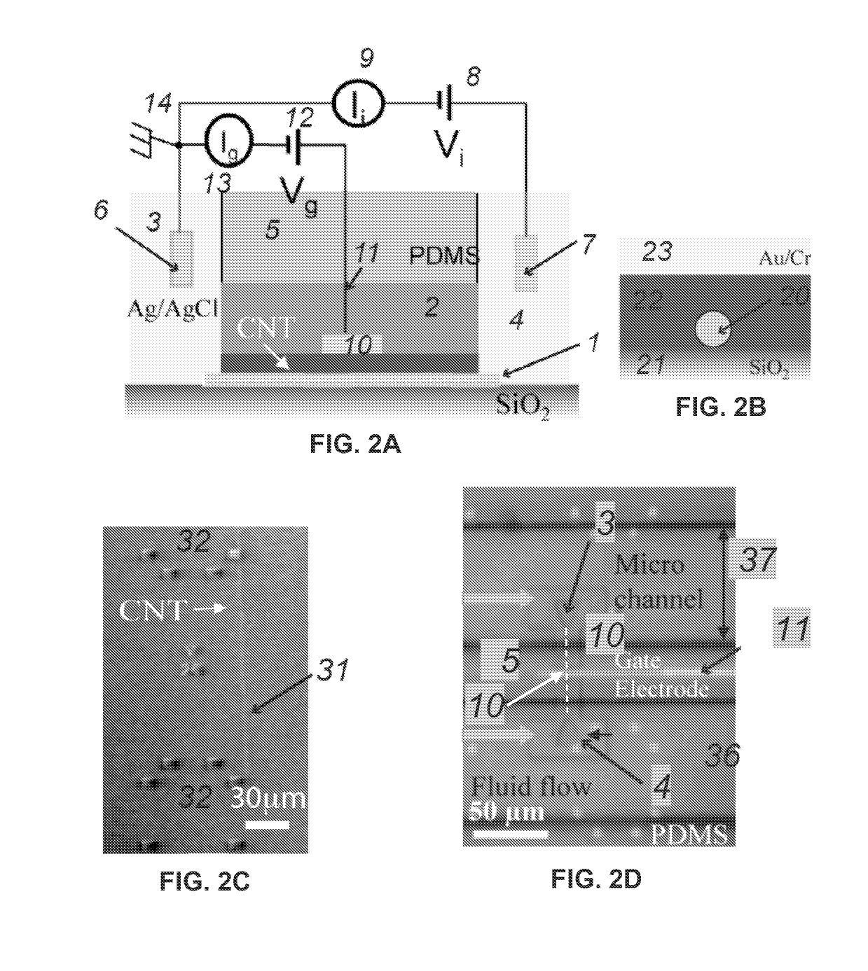

FIG. 2A shows one embodiment of a molecular transistor. A single-walled carbon nanotube 1 spans a barrier 2 separating a first fluid reservoir 3 from a second fluid reservoir 4. The interior of carbon nanotube 1 provides the only fluid connection between the reservoirs 3 and 4. The nanotube may be as short, as 100 mm and as long as several hundred microns. Its diameter is comparable to the hydrated diameter of the molecules whose flow is to be controlled, but at any rate, not so large that two or more molecules could pass simultaneously, if single molecule control is desired. The normal range of diameters in various embodiments may be between about 0.1 and about 100 nm, about 0.1 and about 75 nm, about 0.1 and about 50 nm, about 0.1 and about 25 nm, about 0.1 and about 15 nm, about 0.25 and about 15 nm, about 0.5 and about 15 nm, and preferably about 0.5 and about 10 nm.

Barrier 2 may be formed from a layer of dielectric material including, but not limited to, silicon dioxide (SiO₂), a metal oxide, silicon nitride, or a resist such as polymethylmethacrylate (PMMA). The overall height of barrier 2 is chosen to allow fluid reservoirs 3 and 4 on each side to be filled conveniently, but it is typically, in various embodiments, at least about 25, at least about 50, at least about 75, at least about 100, at least about 250, at least about 500, at least about 750, at least about 1000 nm high, and preferably at least about 100 nm high. The reservoirs etched into the barrier material are connected to an external fluidic system by means of a silicone molded cover 5. Full details of the fabrication of a similar device are given by Liu et al., which is incorporated by reference herein in its entirety,

The reservoirs are filled with an electrolyte. This is generally an aqueous solution of a salt such as sodium chloride or potassium chloride at concentrations between about 1 mM and about 1 M, though many other concentrations and salt solutions may be used. It will be recognized by those skilled in the art that non-aqueous electrolytes (including, but not limited to, propylene carbonate) may also be used. Electrodes 6 and 7 contact the electrolyte solutions in communication with each of the two reservoirs, 3 and 4. In some embodiments, the electrodes may be microfabricated into the reservoirs or placed remotely, so long as they are in contact with a continuous electrolyte connected to the reservoirs. Any conducting material may be used for electrodes 6 and 7, but operation may be more reliable if reference electrodes (including, but not limited to, those that are silver coated with solid silver chloride) are used. Current flow across the carbon nanotube 1 is generated by the application of a bias Vi 8. The consequent current, Ii, may be measured using a current to voltage converter 9 in series with this circuit. These aspects of the device are also as disclosed by Liu et al., which is incorporated by reference herein in its entirety.

A gate electrode 10/23 is shown in FIGS. 2A, 2B, and 2D. In some embodiments, gate electrode 10 is connected to external circuitry by means of a microfabricated lead 11 that passes out of the device under a layer of dielectric material (e.g., barrier 2) that protects it from contact with electrolyte. A bias, Vg, may be applied to the gate via a voltage source 12 connected to a common ground 14 via a current to the voltage converter 13 that monitors the gate current, Ig. As shown in FIG. 2A, one of the electrodes 6 used to drive current through channel 1 is also connected to this common ground 14.

FIG. 2B shows a gate connection in accordance with some embodiments. FIG. 2B shows a cross-section through the device of FIG. 2A, perpendicular to the plane of the page in the region of gate 10. In FIG. 2B, carbon nanotube 20 corresponds to carbon nanotube 1 of FIG. 2A, and lies on top of a SiO₂ surface 21, on which it is grown. After cleaning, a thin layer of dielectric 22 is placed over carbon nanotube 20. This dielectric may be a polymeric material including, but not limited to, polymethylmethacrylate (PMMA) or poly(p-xylylene) polymers (e.g., parylenes). In a preferred embodiment, silicon oxide is deposited, either by spin coating or by e-beam evaporation. In various embodiments, the thickness of this insulating layer may be between about 1 to about 100 nm, about 1 to about 75 nm, about 2 to about 50 nm, about 10 to about 45 nm, about 15 to about 35 nm, and preferably between about 20 to about 30 nm. A gate electrode 23, commonly gold (Au) deposited on a thin layer of chromium (Cr), is evaporated through a window in a resist layer, as is well known to those of ordinary skill in the art. Instead of gold (Au), other materials including, but not limited to, platinum, palladium, titanium, or metallic compounds such as titanium nitride may be used to form gate electrode 23. The dimensions of the electrode are not critical but, in various embodiments, widths of about 0.1 to 50 μm, about 0.25 to about 40 μm, about 0.5 to about 30 μm, about 0.75 to about 25 μm, about 1 to about 20 μm, about 1 to about 15 μm, about 1 to about 10 μm, about 1 to about 5 μm, about 1 to about 2.5 μm, and preferably about 1 to about 10 μm and heights of about 5 to about 100 nm, about 10 to about 90 nm, about 15 to about 80 nm, about 20 to about 70 nm, about 25 to about 60 nm, about 30 to about 50 nm, about 35 to about 45 nm, and preferably about 40 nm Au on top of about 0.1 to about 50 nm, about 0.2 to about 40 nm, about 0.3 to about 30 nm, about 0.4 to about 20 nm, about 0,5 to about 15 nm, about 0.5 to about 10 nm, about 1 to about 10 nm, about 2.5 to about 7.5 nm, and preferably about 5 nm chromium (Cr) may be used.

In accordance with some embodiments, the as-grown carbon nanotube 31 is shown in a scanning electron micrograph in FIG. 2C. Metal markers 32 provide alignment for subsequent lithographic steps.

In accordance with some embodiments, FIG. 2D shows a complete device optically photographed through a silicone fluidic cover. Gate electrode 10 is visible through the silicone and the dielectric barrier. Reservoirs 3 and 4 can be seen etched into the dielectric layer that covers the surface. A silicone barrier 5 separates fluidic channels 36 and 37 that are in electrolyte contact with reservoirs 3 and 4. Fluidic channels 36 and 37 lie on top of the structure shown in FIG. 2A (but are not shown in FIG. 2A). The carbon nanotube is not visible in FIG. 2D, but its location and orientation are approximated by the dashed line between reservoirs 3 and 4.

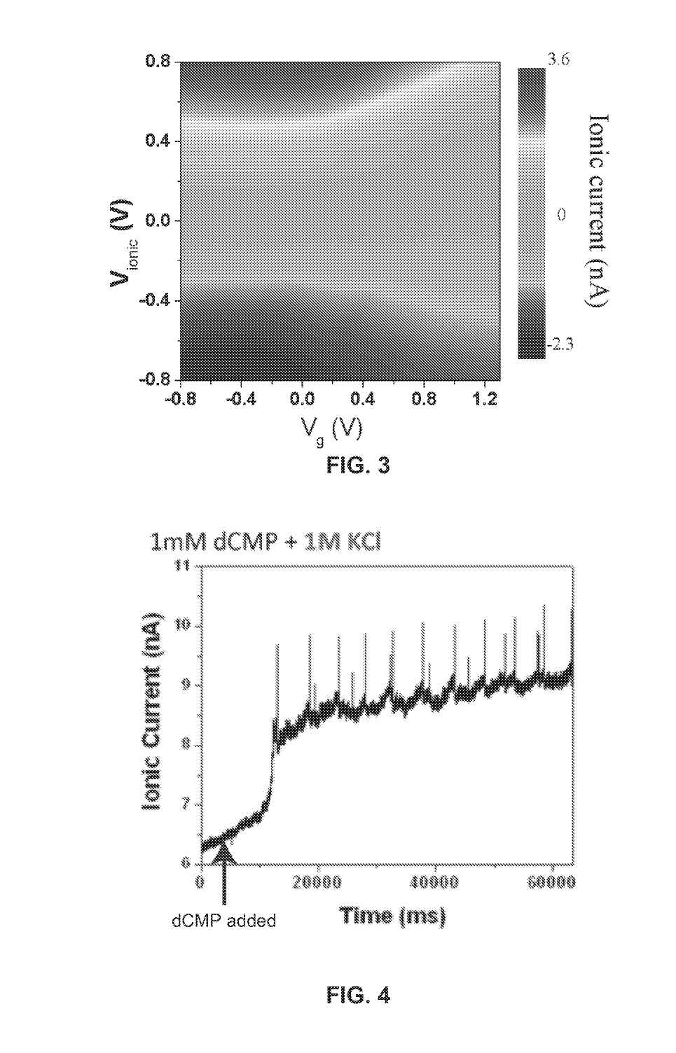

With gate electrode 23 insulated from the channel as shown in FIG. 2B, the molecular transistor can control the flow of ionic current through the carbon nanotube, much as described for the conical nanopore of Kalman et al. (but for which molecular control was not demonstrated). FIG. 3 shows a typical set of characteristics for the molecular transistor in accordance with at least some embodiments. FIG. 3 shows a three dimensional plot of Vi vs. Vg and Ii (shown by the scale on the right) for 1 mM KCl electrolyte. In FIG. 3, flow of ionic current is turned off (i.e., reduced by up to 10×) for a gate bias in excess of about +0.5V.

In at least some embodiments, charged molecules introduced into the fluid reservoir produce giant pulses in Ii, as previously reported for DNA molecules passing through a carbon nanotube. FIG. 4 shows what is observed when a 1 mM solution of deoxycytosinemonophosphate (dCMP) is introduced into the reservoir when that reservoir is biased negative (so that this negative molecule is driven through the nanotube towards the positive reservoir). The background current climbs after introduction of the dCMP molecules, and very large current pulses (seen as discrete spikes) are observed, marking translocation events after a period of time, exactly as reported for DNA molecules. For the data shown in FIG. 4, the gate electrode is not connected, so the device performs exactly as reported for devices without a gate (see, e.g., Liu et al.; and He, J., H. Liu, P. Pang, D. Cao, and S. Lindsay, “Translocation events in a single-walled carbon nanotube,” J. Phys: Condens. Matter 2010; 22:454112, doi: 10.1088/0953-8984/22/45/454112, which describes a single-wailed carbon nanotube that connects two fluid reservoirs by spanning a barrier that separates the reservoirs, but which lacks any gate electrode).

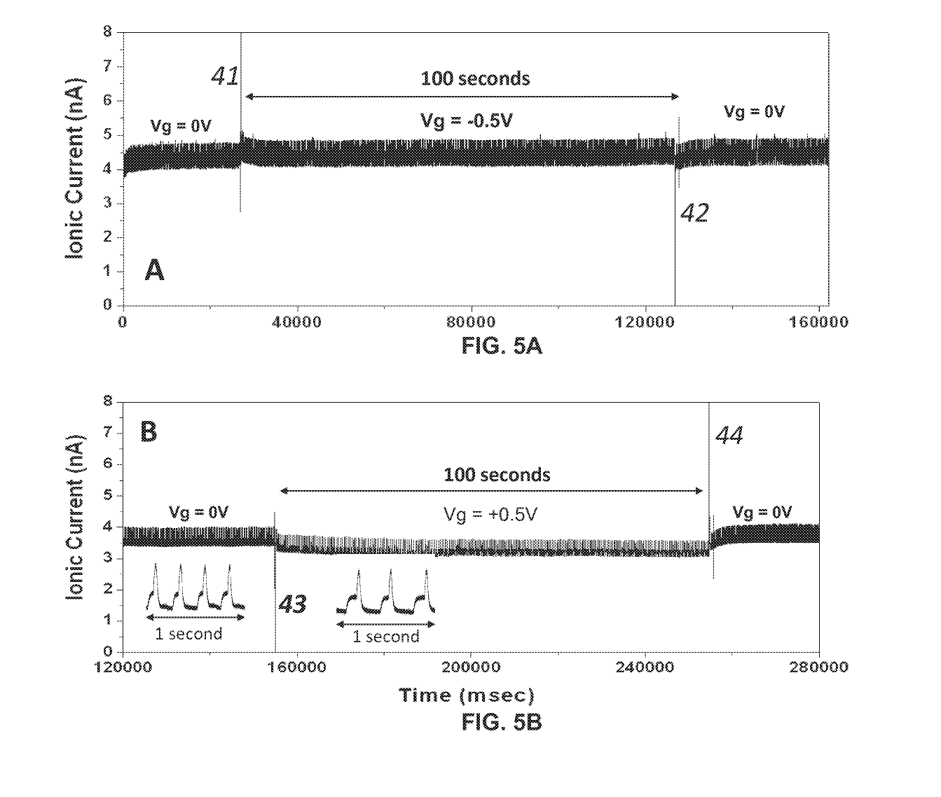

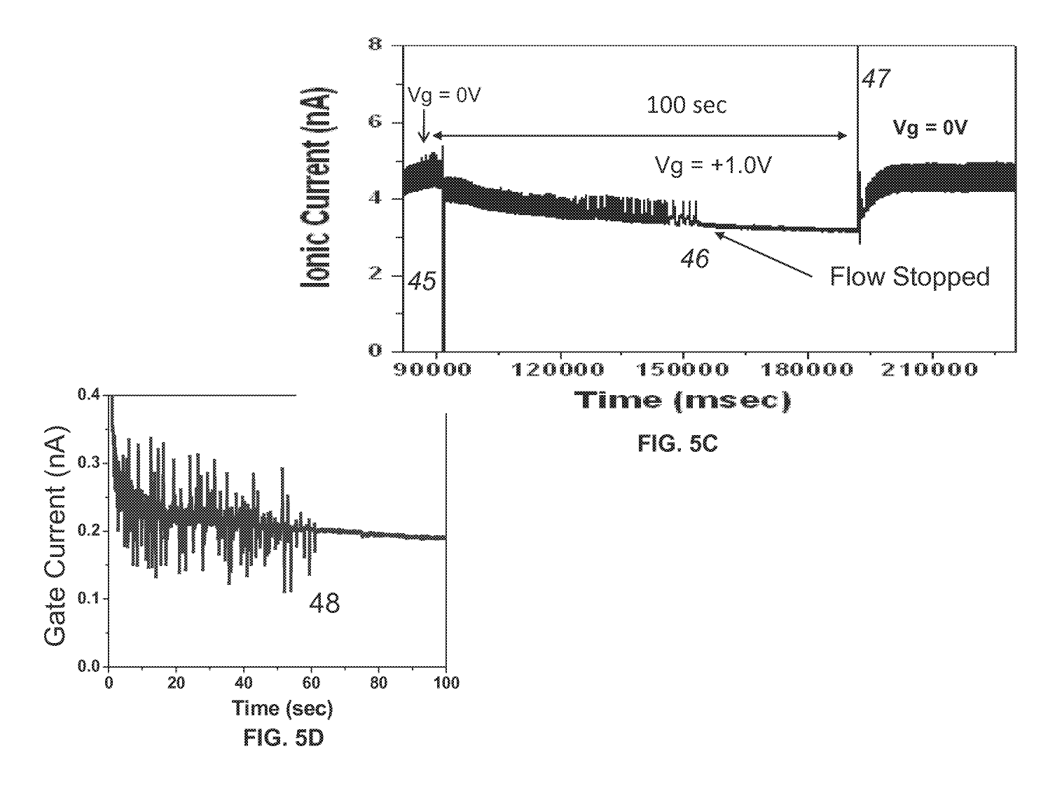

In at least some embodiments, the effects of connecting the gate are illustrated in FIGS. 5A-5D. For the trace shown in FIG. 5A, a bias of Vi=0.6 V was applied, resulting in about 3 translocation events per second (1 mM dCMP in 1M KCl). The spikes are closely spaced, and positive in direction, as shown in FIG. 5A. Here, the gate was initially held at Vg=0 V. At time 41, the gate is switched to Vg=−0.5 V for 100 s until, at time 42, it is switched back to Vg=0 V. There is no measurable change in the translocation rate. The effect of making the gate positive is shown in FIG. 5B. The conditions are the same as those shown in FIG. 5A, but at time 43, the gate is switched from Vg=0 V to Vg=0.5 V for 100 s. The translocation rate is reduced from about 3 per second to about 2 per second until, at time 44, the gate is switched back to Vg=0 V, whereupon the translocation rate returned to about 3 per second. FIG. 5C shows the effect of switching the gate bias to +1 V. Again, the gate is set initially to Vg=0 V and the translocation rate is about 3 per second. At time 45, Vg is set to +1 V for 100 s, after which the pulse rate slowed and stopped at time 46, only being restored when Vg is set back to 0 V at time 47.

The charging and discharging of the carbon nanotube is evident in the spikes in gate current that accompany the transit of molecules, as indicated in FIG. 5D. Notice that these spikes cease when translocation is stopped at time 48. The trace of FIG. 5D corresponds to the final minute prior to the point where the flow of molecules stops at time 46 in FIG. 5C. Thus, it is not necessary to monitor Ii (the current through the tube) to detect a single molecule translocation event, as these events are also evident in the gate current signal Ig. This greatly simplifies the design of massively parallel devices, as many separate carbon nanotubes may span a given pair of reservoirs. The individual translocations through each tube may give signals that add together in Ii, but may be clearly identified in Ig so long as each carbon nanotube has a unique gate connection. Thus, the action of a molecular transistor in accordance with the invention is clearly demonstrated.

The sensitivity of the molecular transistor to the charge carried by a single molecule clearly has applications in the detection of chemical reactions. Pourmand et al. have described how the charge transfer associated with nucleotide additions to many DNA template molecules can be detected by means of the current pulse generated by polarization of a small metal substrate as charge transfer reactions occur. Clearly, by tethering a catalytic molecule to one end of the carbon nanotube in the molecular transistor in accordance with the invention, individual chemical reactions may be detected, either by the release of products into the carbon nanotube channel, or via direct charge transfer into the carbon nanotube, sensed by the gate electrode. Detection of chemical reactions in such a fashion may be accomplished in a manner similar to that described in W0/2009117517 or in W0/2009117522, which are both incorporated by reference herein in their entirety. For example, a DNA polymerase may be tethered to one end of the carbon nanotube via amide linkage chemistry, as is well known in the art, and the addition of single nucleotides detected by means of the resultant charge transfer. The charge transfer may be signaled by an increase in ionic current passing through the tube as a result of the release of a proton as a triphosphate is hydrolyzed on nucleotide addition.

All references cited herein are incorporated by reference herein in their entirety as though each reference was specifically and individually indicated to be incorporated by reference. The citation of any reference herein should not be construed as an admission that the present disclosure is not entitled to antedate such reference by virtue of prior invention.

Although the invention has been described and illustrated in the foregoing illustrative embodiments, it should be understood that this disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A device comprising:
a channel having a diameter such that only one target molecule at a time may traverse the channel; and
a gate electrode; wherein:
the channel is electrically isolated from and in communication with a gate electrode.

2. The device of claim 1, wherein the channel comprises a carbon nanotube.

3. The device of claim 1, wherein the channel diameter is between about 0.1 and about 100 nm.

4. The device of claim 1, further comprising a layer of dielectric material surrounding the channel and providing electrical isolation between the channel and the gate electrode.

5. The device of claim 4, wherein the layer of dielectric material is between about 1 and about 50 nm thick.

6. The device of claim 4, wherein the dielectric material is selected from the group consisting of an oxide of silicon and polymethylmethacrylate.

7. The device of claim 1, further comprising a first fluid reservoir and a second fluid reservoir, wherein the interior of the channel provides the only fluid connection between the first and second fluid reservoirs.

8. The device of claim 7, wherein the first and second reservoirs are each filled with an electrolyte.

9. The device of claim 7, further comprising:
a first electrode in contact with the first reservoir; and
a second electrode in contact with the second reservoir.

10. The device of claim 1, further comprising a voltage source coupled to the gate electrode.

11. A method for controlling the flow of a molecule, the method comprising:
providing a device comprising a channel, wherein the channel:
has proximal and distal ends, and a diameter such that only one target molecule at a time may traverse the channel;
is electrically isolated by a layer of dielectric material; and
is in communication with a gate electrode, wherein the gate electrode has a voltage potential and a gate current;
providing a molecule to the proximal end of the channel;
detecting the gate current of the gate electrode; and
controlling the voltage potential of the gate electrode, thereby controlling the flow of the molecule.

12. The method of claim 11, further comprising detecting a current spike in the gate current, thereby detecting translocation of a molecule through the channel.

13. The method of claim 11, wherein controlling the voltage potential further comprises increasing the voltage potential of the gate electrode to reduce the flow of the molecule.

14. A method for detecting a single chemical reaction, the method comprising:
providing a device comprising a channel, wherein the channel:
comprises a carbon nanotube having proximal and distal ends and a catalytic molecule tethered to the distal end, the carbon nanotube further having a diameter such that only one target molecule at a time may traverse the channel;
is electrically isolated by a layer of dielectric material; and
is in communication with a gate electrode, wherein the gate electrode has a voltage potential and a gate current;
providing a molecule to the proximal end of the channel; and
detecting the gate current of the gate electrode, thereby detecting a single chemical reaction.

15. The method of claim 14, further comprising controlling the voltage potential of the gate electrode.

16. The method of claim 14, wherein detecting the gate current further comprises detecting a spike in the gate current, thereby detecting a single chemical reaction.
